(19) United States
(12) Patent Application Publication
(10) Pub. No.: US 2006/0154693 A1
(43) Pub. Date: Jul. 13, 2006

(54) Wireless electronic system and method based on cellular phone

(75) Inventor: Ilya Kogan, Brooklyn, NY (US)

Correspondence Address: ILYA KOGAN, 2573 E. 27TH ST., BROOKLYN, NY, 11235, US

(73) Assignee: Mr. Ilya Kogan, Brooklyn, NY (US)

(21) Appl. No.: 10/905,635

(22) Filed: Jan. 13, 2005

(51) Int. Cl. H04B 1/38; H04M 1/00

(52) U.S. Cl. 455/557

(57) ABSTRACT

The present invention discloses a system and method for multiple-purpose and more effective usage of cellular phone in electronic devices and every day life. In the proposed system are combined modern cellular phones with many electronic devices such as: PC, TV, printers, web cams, hubs, traditional telephones, and so on. The above provides a possibility to eliminate some of these devices and some services. In addition it saves expenses and enlarges the convenience of life.

### BACKGROUND OF THE INVENTION

1. Field of the Invention

This invention relates to the field of information technology and telecommunications. The goal of the invention is to improve everyday usage of a rising set of devices related to the PC, phone, TV, and many other devices related to the named: camcorders, VCRs, cameras, printers, and so on. It is necessary to stress that the majority of such devices are not used simultaneously. The rising service makes even some inconvenience, e.g. it is good to get a cellular phone with the number equal to your stationary one. On the other hand one loses possibility to have the same number on the stationary phone and often needs two phone numbers instead of one.

2. Description of the Related Technology

A household or an office uses a set of devices for transforming information and communication that increases with time. The number of such devices and their usage needs enlarging qualification, knowledge, time, and expenses from the user. In addition some of the devices are bounded to locations of special outlets.

A typical household or an office has many devices with doubling or analogous functions. E.g. camcorders, cameras, web cams, and cellular phones; telephone lines for conversation, faxes, internet, and cellular phones; cables for TV and receiving TV on cellular phones; walkmans and CD players; and so on.

Some companies and inventors try to fight the above. E.g. the MUSTEK's device DV-4500 has 7 functions. Usage of hubs serves the same goal. Motorola supplies a cable 98653H for connection the cellular phone to PC through a USB port, but this is not a standard cable. In the patent number 20020068529 is offered an additional not a simple and rather expensive device to eliminate the problem only partially. To say nothing, that this device needs ether an antenna with all the possibilities of a cellular phone inside, or the cellular phone, not both of them.

Modern cellular phones are multi functional and their features grow with time. On the other hand they are still pocket devices and at home or in the office are used for similar functions other devices. Often it is done because those devices are more convenient. E.g. stationary phone has many functions which most of the users prefer to the cellular ones. In addition, one person needs two different phone numbers: one for stationary phone and one for the cellular one.

Implementation of proposed system would widen the cellular phones usage, lead to enlarge their possibilities and allows making this service cheaper. It would allow reducing redundancy in hardware and simplifying the maintenance. It would allow having many new features like a videophone or teleconferencing by using the TV or PC screens.

Implementation of the proposed system through a hub makes it possible to use different functions of the cellular phone simultaneously in different devices. On the other hand it may be useful to equip the cellular phone with an input for a standard remote control and with a stand like the one for charging electric razors.

### SUMMARY OF THE INVENTION

The invention provides a system and method for:

reducing hardware redundancy, e.g. web cam;

reducing additional services as phone cables or (to some extent) TV cable service and internet cable;

possibility of usage of a multi functional device-cellular phone features simultaneously in different stationary devices;

simplifying maintenance, what is very important for majority of users;

reducing the costs related to all the above.

Wireless electronic system and method based on cellular phone does not require new standards. On the other hand, they allow by changing of scheme and structure of cellular phone and adding new inputs to home information and communication devices to get a completely new quality in usage of multiple electronic devices and phone communication systems.

To achieve the above benefits it is not required any special equipment, adapters, or devices. The necessary changes in the cellular phone structure are minor and are introduced in the drawings. In addition it is necessary one of the following cable connections:

1. Standard USB cable—these need to have a USB output in the cellular phone and USB inputs (outputs) for the devices which do not have it, e.g. stationary phones. For example, in the space of an existing output in a Motorola V600 can be placed both a USB input and output. Electric current for recharging can also pass though the USB.

2. Standard phone cable (as a temporary solution), which needs an input for itself in the cellular phone.

3. A cable (like Motorola 98653H) with one end connected to the existing cellular phone input (output) and the other end with standard stationary phone input.

4. Existing cable (like Motorola 98653H), which can connect to the USB.

5. A cable from cellular phone to TV with coaxial end, or any other for the existing TV standard input.

The usage through a hub needs some special type of hub and some changes in the cellular phone structure (see drawings).

### DETAILED DESCRIPTION OF THE INVENTION AND DRAWINGS

The goal of this invention is to improve and make more effective usage of information technology and communication devices. With time the diversity and number of the devices in a household or in an office will increase. This make more difficult the maintenance and even usage of the devices. Every device has some fifty page manual. In parallel there are created multi functional devices. One of very widely used is the cellular phone. Every next model adds new functions and possibilities to the cellular phones. The microminiaturization would allow enlarging the new feature qualities to the highest standards in the nearest future.

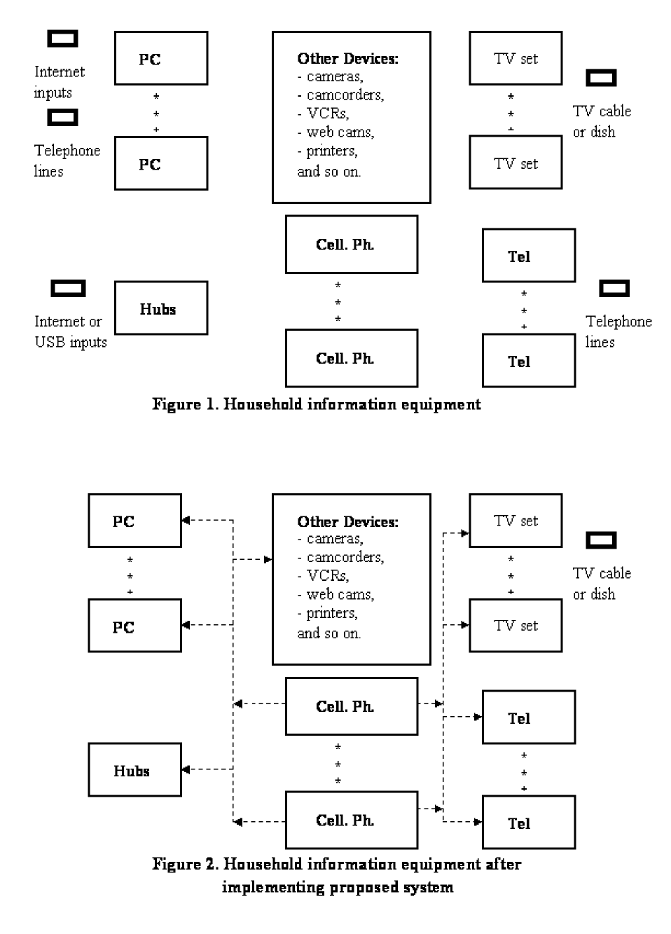

Today's typical household looks as it is shown in the FIG. 1. In addition there is a dense web of connections between the shown items. The only separate items are (to some extent) cellular phones. It is necessary to stress that those TVs, PCs, VCRs, cameras, camcorders, and so on are not in a single copy. E.g. in our house for six of us (two families, one consisting of two seniors) there are: four phone lines with some 7 stationary phones, two TV cable inputs, four PCs and laptops, 5 cellular phones, 6 TV sets, 8 VCRs, 2 hubs, a lot of cameras, camcorders, printers, copiers and scanners, faxes, and other equipment. On my knowledge we are not an exception.

The majority of such devices are not used simultaneously. The percent of usage of those devices is near zero, but all of them need some knowledge in our memory. All need to buy warranty to say nothing that they themselves are expensive and very quickly become out-of-date. The only constantly up-to-date devices are the cellular phones, which are updated every year.

The goal of the invention is to improve the everyday usage for a rising set of devices related to the PC, phone, TV, and many others related to the named devices, like: camcorders, VCRs, cameras, printers, and so on. The rising service makes even some inconvenience, e.g. it is good to get a cellular phone with the number equal to your stationary one. On the other hand one loses the option to have the same number on the stationary phone. This doubles the volume of personal phone books and leads to necessity for new area codes. It is a necessity to fight this escalation of the number and complexity of electronic and communication devices in everyday usage. This is the goal of proposed system.

It is necessary to stress that the goal of the proposed system is really very simple and narrow—to decrease the number of devices in everyday usage. This is seen from the FIG. 2 where it is shown the same household after implementing the proposed system. Now the main sources of the input-output information are the cellular phones. The connections are shown as dotted lines because they are not permanent. The cellular phones are still mostly in the pockets as now. On the other hand it has nothing to do with usage of super cameras for special purposes, or noise-secured lines. But the inventor believes that the possibilities and quality of the features offered by cellular phones would surpass today's cameras, camcorders, and so on in the nearest future.

The changes required in the hub are minor if it has a USB input. The changes desirable in the TV are a USB input; this is necessary for the upcoming digital standard. The changes in the stationary line phones (USB input) are needed only for eliminating the special cable. All the above can be done in many ways and has already many implementations in information technology. That's why below are presented only the changes in the cellular phone structure.

It is necessary to mention that in the nearest years it would be still necessary coaxial cables or satellite antennas for multi channel TV.

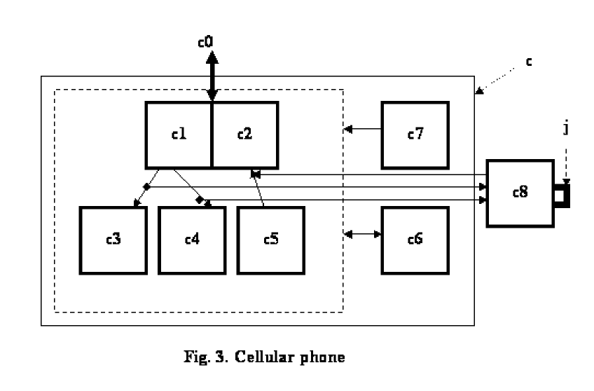

In the FIG. 3 is given the structure of the cellular phone c, which is convenient for this case, where:

c0—antenna;

c1—input signal decoder;

c2—output signal coder;

c3—ringer;

c4—microphone;

c5—speaker;

c6—other features and services;

c7—power supply.

To the cellular phone are added:

c8—which includes a switch to redirect signals, coder (block c1) to code the signals from antenna to needed standard, e.g. the telephone line standard, and block c2 to convert signals from incoming standard, e.g. from the telephone line to the cellular phone transmitting;

j—jack for one of the cables mentioned in [Para 19-24].

The device shown in the FIG. 3 would be called modified cellular phone. Such phone is ready e.g. for usage with a normal stationary phone instead of a standard telephone line, or with a TV as videophone. It means that the line would not be needed.

The big advantage of the proposed system and method is the simplicity of implementation. It does not require new standards and technology or any additional devices. The proposed telephone schemes may be created based on existing technology. Separately every scheme and part of the invention has been used for years, but in different ways and in different combinations. If the necessary scheme is included (added) to the stationary phone, it does not need the connection to the cellular one and would not need a cable system.

A cellular phone as defined in claim 1 has ether a modified outlet (a USB one), or in the simplest case a special output cable, e.g. with one end as standard telephone cable. In this case the cellular phone performs the following functions:

It translates the receiving signals to the standard form, which the stationary phone receives from the cable;

It translates incoming cable signals to the standard form of transmitting wireless signals.

While we have shown and described specific embodiments of the present invention, further modifications and improvements will occur to those skilled in the art. It is therefore to be understood that appended claims are intended to cover all such modifications and changes as fall within the true spirit and scope of the invention.

What is claimed is:

1. A method which allows with minor changes in the modern cellular phone and without any additional devices to eliminate and simplify usage of many electronic and communication devices of everyday life. The proposed method enlarges the efficiency of the devices by implementing standard connections. It allows simplifying and making cheaper the usage of the more and more necessary and widely used devices. The method allows (due to the modern multi functional cellular phone) to decrease the number of necessary equipment. The method claims also to use a cellular phone as an input to a hub from which are working many home devices.

2. The method according to claim 1, allows to eliminate any special connection to the internet such as cable or telephone line. The PC has such means and modern cellular phones have to some extent such possibilities as well, but for some reasons they are not standard, but individual for near every phone model (e.g. cables for connection to USB).

3. The method according to claim 1, allows to receive TV programs and video phone conversations on big TV or PC screens directly through the cellular phone. The cellular phones have such possibilities; today's TV does not. Temporarily can be used a coaxial cable output from the cellular phone, and any other available in TV. In the nearest future digital TV must have a USB input. A USB output from a cellular phone already exists.

4. The method according to claim 1, allows to use a cellular phone as a web cam with a PC or laptop. This eliminates the necessity of a separately purchased web cam.

5. The method according to claim 1, allows to use a conventional stationary phone without a phone line and without any additional adapters or other devices. This needs only some minor changes in the cellular phone. Comparing to the functions the cellular phones already have this addition is minor. It is necessary to stress that analogous features for other purposes already exist in the cellular phones. In addition it would be necessary to have a cable which has from one end connection to the cellular phone and from the other a standard telephone connection. In the future the stationary phones should have USB input. This would eliminate the temporary proposed cable.

6. The method according to claim 5, allows to eliminate the necessity of telephone lines and does not bind the telephone position next to the line outlet. The widening of cellular phone usage would make it cheaper and elimination of the bill for telephone lines would improve the economy.

7. The method according to claim 1, allows to use the cellular phone with any standard devices that have a USB input, e.g. printers, to print the pictures directly from the cellular phone; or VCRs.

8. The method according to claims 2-7, makes it necessary to create stationary phones with some functions of a cellular phone. This follow from the widening usage of cellular phones and necessity of more channels, as now it makes necessity for additional tracks for stationary phone lines, e.g. for internet. In addition the standard telephone line does not support some functions of the cellular phones due to frequency limitations.

9. The method according to claims 1-8, allows to use the cellular phone as an input to a, slightly modernized, hub for transferring the signals to different devices.

10. The method according to claim 9, makes it useful to create stationary phones with (wireless) inputs from a hub in addition to the other types of phones.
